(19) United States
(12) Patent Application Publication
(10) Pub. No.: US 2017/0228767 A1
(43) Pub. Date: Aug. 10, 2017

(54) METHODS AND SYSTEMS FOR INTERACTIVE MARKETING CAMPAIGNS AND ANALYTICS

(71) Applicant: Behavioral Analytics, LLC, Wellesley, MA (US)

(72) Inventors: David J. Morton, Dover, MA (US); Vincent J. DiPippo, Johnston, RI (US); Carl R. Katzeff, Chestnut Hill, MA (US); Christopher J. Delaney, Hopkinton, MA (US)

(21) Appl. No.: 15/382,131

(22) Filed: Dec. 16, 2016

Related U.S. Application Data
(60) Provisional application No. 62/269,665, filed on Dec. 18, 2015.

(51) Int. Cl. G06Q 30/02; G06Q 50/00; G06Q 10/10

(52) U.S. Cl. CPC G06Q 30/0245; G06Q 10/107; G06Q 50/01; G06Q 30/0269

(57) ABSTRACT

Computer methods and systems create customer engagement marketing material. Features include qualifying and engaging customers and prospects through interactive marketing campaigns and analytics. Embodiments of the invention can provide a web-based, integrated platform for engagement automation, content creation/management, and data collection. Web-based system embodiments can send customized content or campaigns through a plurality of channels including email and social media networks, collect and analyze data related to a bi-directional engagement campaign, issue reports providing information on the behavior and response of recipients of the engagement material, inform modifications to the engagement campaign and leverage automated workflow, and create dynamic groups to be targeted based on analyzed data and information.

### RELATED APPLICATION

This application claims the benefit of U.S. Provisional Application No. 62/269,665, filed on Dec. 18, 2015. The entire teachings of the above application are incorporated herein by reference.

### BACKGROUND

Existing email and customer relationship management (CRM) systems support the issuance and tracking of marketing and sales efforts. However, after a user of such systems posts and tracks emails sent and received by the user, the user does not receive rich data and analysis to modify and better target a campaign based on collected data and analysis on the reaction, response, and behavior of recipients of the campaign.

### SUMMARY OF THE INVENTION

Embodiments of the invention enables a web-based, integrated platform for engagement automation, content creation/management, and data collection. Web-based system embodiments can send customized content or campaigns through a plurality of channels including email and social media networks, collect and analyze data related to a bi-directional engagement campaign, issue reports providing information on the behavior and response of recipients of the engagement material, inform modifications to the engagement campaign and leverage automated workflow, and create dynamic groups to be targeted based on analyzed data and information.

One example embodiment of the invention is a computer system for bi-directional customer engagement. The system includes a processor configured to provide one or more templates that embody behavioral scientific engagement patterns paired with one or more visual layouts and content designs, and an interface coupled to the processor and configured to provide, in conjunction with the processor, a set of questions from which one or more questions are to be incorporated in engagement campaign material designed to elicit prospect engagement with a customer and identify prospect behavior of the customer.

Another example embodiment of the invention is a computer implemented method of bi-directional customer engagement. The method includes providing, by a processor, one or more templates that embody behavioral scientific engagement patterns paired with one or more visual layouts and content designs, and providing, by the processor and an interface, a set of questions from which one or more questions are to be incorporated in engagement campaign material designed to elicit prospect engagement with a customer and identify prospect behavior of the customer.

The system or method may adaptively suggest questions for inclusion in the engagement campaign material based on criteria entered, questions that have been used previously, and question performance in previous campaigns. The system or method may identify an interest of the customer in particular content, customize an email to the customer based on the interest and the engagement campaign material, and track and report behavior and response of the customer. Further, the system or method can create a group of customers with similar interests. The system or method may identify and distribute the engagement campaign material through one or more email services and social media channels, and the engagement material may include an interactive set of questions to engage readers who click-through received engagement material. The system or method may identify aggregate prospect engagement responses into a database and employ automated analytical algorithms to identify and rank qualified prospect leads. The system or method may display a dashboard providing data on prospect engagement and metrics on the engagement campaign. The user base of the system may be segmented, segregated, or grouped by organizational hierarchy (e.g., sales, sales managers, sales executives; marketing, marketing managers, marketing executives, etc.), engagement activities, or engagement campaigns.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a flow diagram illustrating bi-directional customer engagement, according to an example embodiment of the present invention.

FIG. 2 is a flow diagram illustrating bi-directional customer engagement, according to an example embodiment of the present invention.

FIG. 3 is a flow diagram illustrating bi-directional customer engagement, according to an example embodiment of the present invention.

FIG. 4 is a schematic diagram illustrating an example user interface of an embodiment of the present invention.

FIG. 5 is a block diagram illustrating a computer network, system, or similar digital processing environment in which embodiments of the present invention may be implemented.

FIG. 6 is a block diagram of an example internal structure of a computer in the computer system of FIG. 5.

### DETAILED DESCRIPTION OF THE INVENTION

A description of example embodiments of the invention follows.

Embodiments of the invention include innovative methods and systems with a set of procedures that can, for example, (i) identify customer interest in content, (ii) customize email engagement material and campaigns in response to detection and analysis of customer interest, (iii) report individual customer behavior and responses, and (iv) create dynamic groups with similar interests and needs. The methods and systems are designed to optimize the use of online engagement campaigns through one or more email services, websites, and social media channels by creating original material and campaigns that draw in and target audiences to engage online with the company. Target audience behavior may be analyzed, and the user can enhance and improve engagement material and bi-directional engagement with a higher qualification of leads than other systems.

Use of the methods or systems can provide an integrated platform for engagement automation, content creation/management, and data collection (vs. separate applications or modules). Using the methods or systems, non-professional designers can create content appropriate to multiple audiences and devices and intuitively and intrinsically produce content that is appropriate to a plurality of distribution methods and channels. The methods or systems can provide pre-built templates that embody not only the visual layout and design of content but the behavioral scientific engagement patterns that are paired therewith. Engagement questions can be suggested adaptively based on criteria entered, questions that have been used previously, and question performance in previous campaigns. The methods or systems can be used to, for example, (i) aggregate and segment data to illustrate channel usage, (ii) obtain and display descriptive characteristics of email campaigns to build individual and group profiles of targeted individuals and companies, and (iii) analyze optimal email and social media channels to use in campaigns

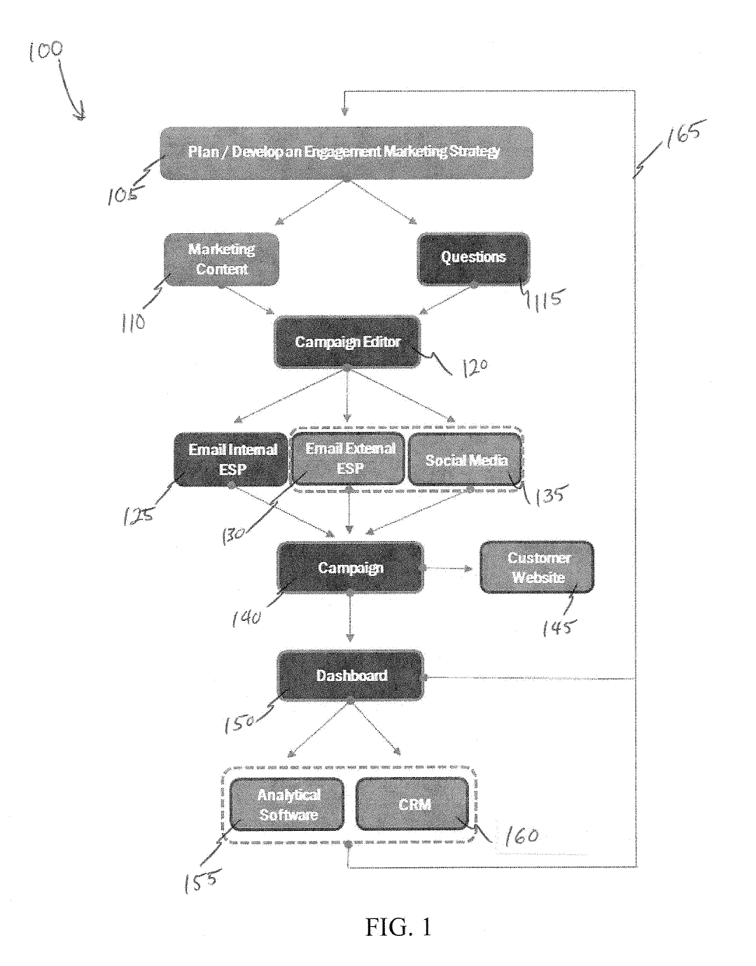

FIG. 1 is a flow diagram 100 illustrating bi-directional customer engagement, according to an example embodiment of the present invention. A user may develop engagement material and design an initial engagement campaign that identifies targeted lists, leads, goals, and sales approach (105). The user can choose from various templates and behavioral questions to create engagement materials that incorporate the questions and the user's engagement content (110, 115). The user can specify classification criteria for specific requirements, which are used in an adaptive algorithm to suggest template questions from a mutable library (115). The algorithm considers the criteria entered, the questions that have been used previously, and their relative performance vis-à-vis the responses they have garnered. The user can use a campaign editor to adopt preset rules or modify rules that limit the number of emails sent to a particular domain in order to avoid blacklisting (120). The user may create group or individual campaigns, and the system can provide a “pre-flight” check list that identifies issues with emails prior to issuance to enable the user to correct, modify, or accept emails prior to distribution. The user may then send customized material directly through one or more email service, commercial email services (such as Gmail, Office365, Rackspace, etc.), and social media channels (such as Facebook, Twitter, LinkedIn, Google+, etc.) (125, 130, 135). API and SMPT connections to third-party email service providers allow routing emails to multiple providers (130). Social links to company pages may be included on an end user's campaign landing page. Users can post to social media with social media integrations that allow editing and preview before posting. The system also provides the ability to copy and paste a link to a campaign landing page to allow distribution anywhere (135). The system captures the actions of recipients of the engagement material, including no response, click-through by individual links in emails, and subsequent interaction with the website (for example downloading of particular white papers or brochures) (140). The system can displays all data related to the campaign within a dashboard, including prospect number of visits, responses, reaction to individual campaigns, recipient profile (e.g., sales, marketing, engineering, director, VP, etc.), and other online behavior and interaction based on users permission settings (150). The system may also provide all data and information to create prospect profiles and identify successful aspects of each engagement campaign. The user may use other analytical software and CRM systems to analyze data, metrics and information provided by the system (e.g., SAS, Excel), and the sync data and information with CRM systems (e.g., Salesforce.com) (155, 160). The user may then use the data and analysis to enhance the engagement campaign, materials, and emails or implement a new engagement campaign that incorporates learning from prior campaigns (165).

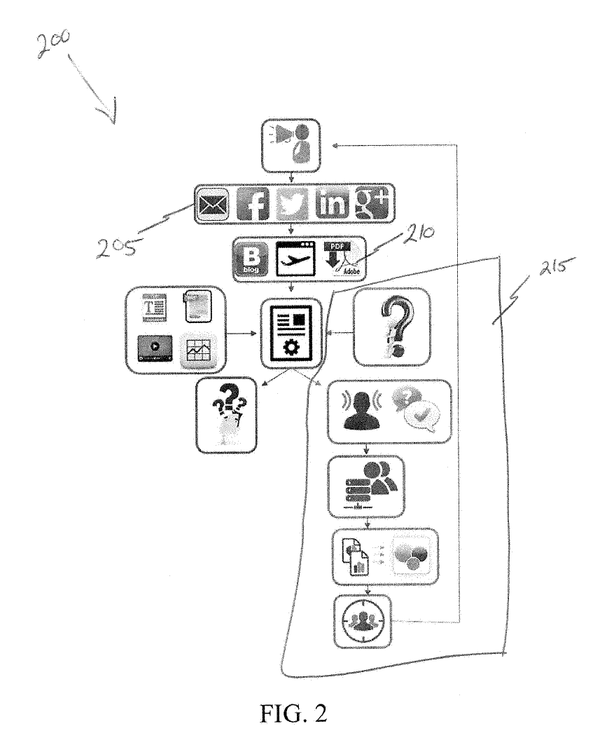

FIG. 2 is a flow diagram 200 illustrating bi-directional customer engagement, according to an example embodiment of the present invention. FIG. 2 illustrates a variety of third-party applications and tools with which the system may be integrated, as well as a process of prospect engagement. Integration may include social media channels 205 (e.g., Facebook, Twitter, LinkedIn, Google+ and mail services such as Gmail and Outlook) and applications 210 (e.g., PDF, video, Excel, and Word). The process denoted by 215 (the right-hand column under and including the large question mark input and looping to the beginning) illustrates prospect interaction through the use of customized questions that are based on scientific behavioral analytics. The prospect can be sent material with questions that draw in recipients interested by the questions. A user clicks a question of interest, taking the user to customized material, additional questions, and links to directly engage with the company. The system tracks and reports on these interactions to inform ongoing engagement campaigns and new campaigns.

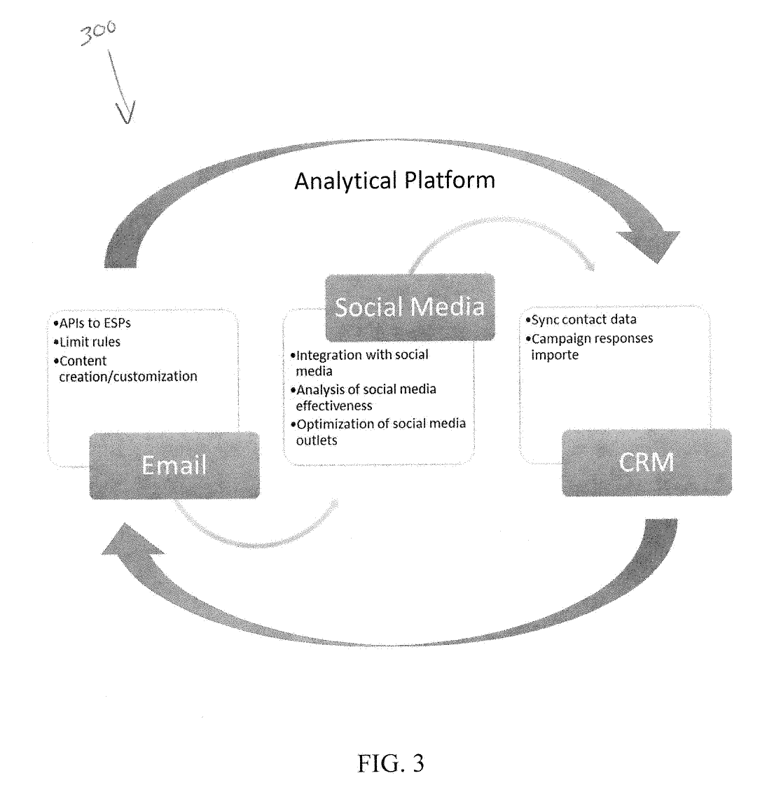

FIG. 3 is a flow diagram 300 illustrating bi-directional customer engagement, according to an example embodiment of the present invention. FIG. 3 highlights two interactive processes of the system and its use of a feedback loop to improve and enhance the engagement process to lead to significantly greater response rates, qualified leads, and increased sales.

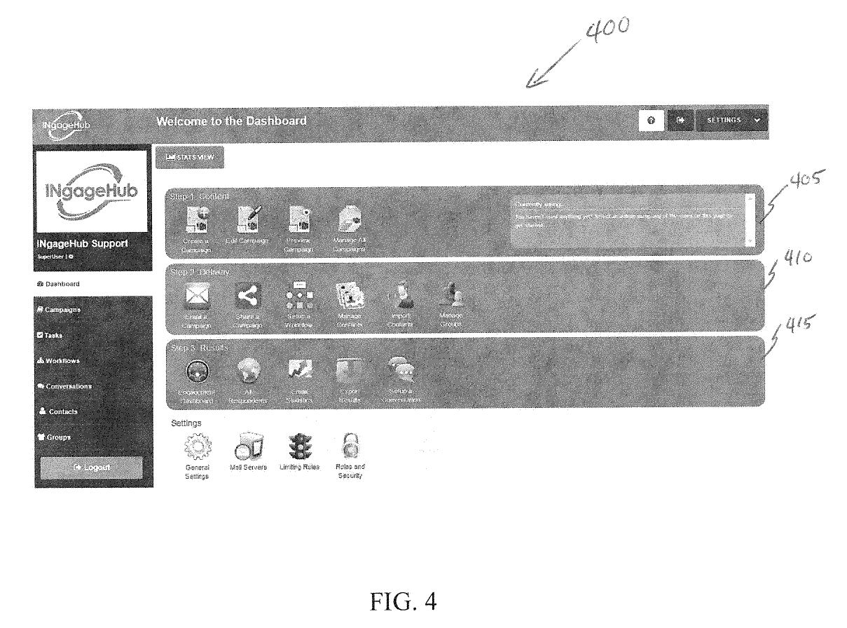

FIG. 4 is a schematic diagram illustrating an example user interface 400 of an embodiment of the present invention. FIG. 4 illustrates a dashboard including engagement campaign material development 405, engagement campaign material delivery 410, and analysis of the actions of recipients of the engagement material 415.

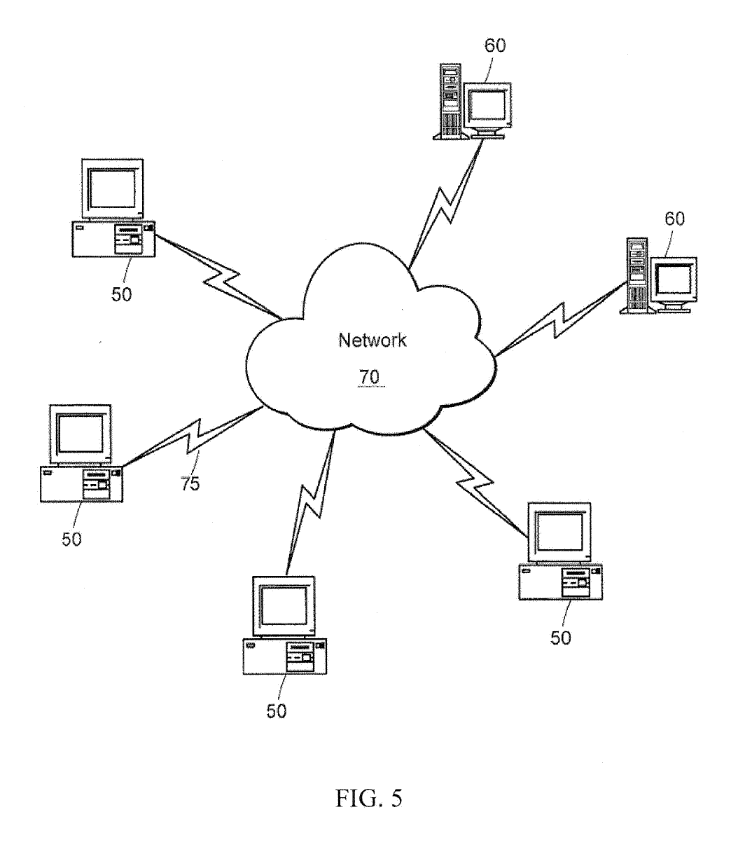

FIG. 5 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60, via communication links 75 (e.g., wired or wireless network connections). The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

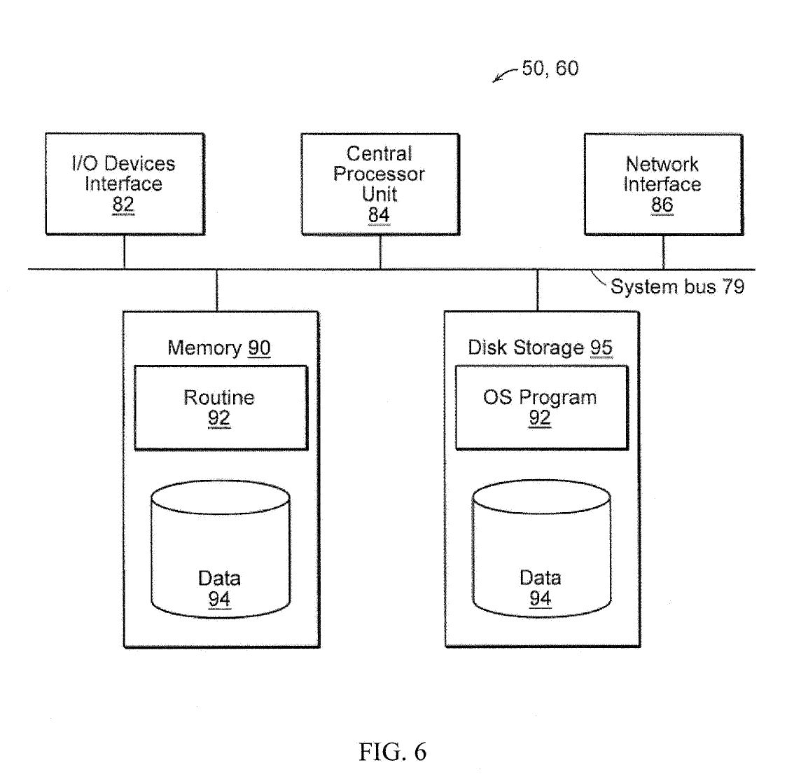

FIG. 6 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention. Disk storage 95 provides non-volatile, non-transitory storage for computer software instructions 92 and data 94 used to implement an embodiment of the present invention. A central processor unit 84 is also attached to the system bus 79 and provides for the execution of computer instructions. The disk storage 95 or memory 90 can provide storage for a database. Embodiments of a database can include a SQL database, text file, or other organized collection of data. In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

While this invention has been particularly shown and described with references to example embodiments thereof, it will be understood by those skilled in the art that various changes in form and details may be made therein without departing from the scope of the invention encompassed by the appended claims.

What is claimed is:

1. A computer system for bi-directional customer engagement, the system comprising:
a processor configured to provide one or more templates that embody behavioral scientific engagement patterns paired with one or more visual layouts and content designs; and
an interface coupled to the processor and configured to provide, in conjunction with the processor, a set of questions from which one or more questions are to be incorporated in engagement campaign material designed to elicit prospect engagement with a customer and identify prospect behavior of the customer.

2. A computer system as in claim 1 wherein the processor is configured to adaptively suggest questions for inclusion in the engagement campaign material based on criteria entered, questions that have been used previously, and question performance in previous campaigns.

3. A computer system as in claim 1 wherein the processor is configured to identify an interest of the customer in particular content.

4. A computer system as in claim 3 wherein the processor is configured to customize an email to the customer based on the interest and the engagement campaign material.

5. A computer system as in claim 4 wherein the processor is configured to track and report behavior and response of the customer.

6. A computer system as in claim 3 wherein the processor is configured to create a group of customers with similar interests.

7. A computer system as in claim 1 wherein the processor is configured to identify and distribute the engagement campaign material through one or more email services and social media channels.

8. A computer system as in claim 7 wherein the engagement material includes an interactive set of questions to engage readers who click-through received engagement material.

9. A computer system as in claim 1 wherein the processor is configured to aggregate prospect engagement responses into a database and to employ automated analytical algorithms to identify and rank qualified prospect leads.

10. A computer system as in claim 1 wherein the interface is configured to display a dashboard that provides data on prospect engagement and metrics on the engagement campaign.

11. A computer system as in claim 1 wherein the processor is configured to segment, segregate, or group a user base by organizational hierarchy, engagement activities, or engagement campaigns.

12. A computer implemented method of bi-directional customer engagement, the method comprising:
providing, by a processor, one or more templates that embody behavioral scientific engagement patterns paired with one or more visual layouts and content designs; and
providing, by the processor and an interface, a set of questions from which one or more questions are to be incorporated in engagement campaign material designed to elicit prospect engagement with a customer and identify prospect behavior of the customer.

13. A computer implemented method as in claim 12 wherein providing the set of questions includes adaptively suggesting questions for inclusion in the engagement campaign material based on criteria entered, questions that have been used previously, and question performance in previous campaigns.

14. A computer implemented method as in claim 12 further including identifying an interest of the customer in particular content.

15. A computer implemented method as in claim 14 further including customizing an email to the customer based on the interest and the engagement campaign material.

16. A computer implemented method as in claim 15 further including tracking and reporting behavior and response of the customer.

17. A computer implemented method as in claim 14 further including creating a group of customers with similar interests.

18. A computer implemented method as in claim 12 further including identifying and distributing the engagement campaign material through one or more email services and social media channels.

19. A computer implemented method as in claim 12 further including aggregating prospect engagement responses into a database and employing automated analytical algorithms to identify and rank qualified prospect leads.

20. A computer implemented method as in claim 12 further including:
displaying a dashboard that provides data on prospect engagement and metrics on the engagement campaign; and
segmenting, segregating, or grouping a user base by organizational hierarchy, engagement activities, or engagement campaigns.
